(19) United States
(12) Patent Application Publication
(10) Pub. No.: US 2018/0048181 A1
(43) Pub. Date: Feb. 15, 2018

(54) UNINTERRUPTIBLE POWER SUPPLY

(71) Applicant: Szu Chi LO, Nantou City (TW)

(72) Inventor: Szu Chi LO, Nantou City (TW)

(21) Appl. No.: 15/236,951

(22) Filed: Aug. 15, 2016

(51) Int. Cl. H02J 9/06

(52) U.S. Cl. CPC H02J 9/061

(57) ABSTRACT

An uninterruptible power supply contains: a plurality of power control devices, a cloud main controller, and multiple plugs. The plurality of power control devices are in connection with a power source, and the plurality of power control devices include cloud power management controllers, storage batteries, code readers, and sockets, respectively. The multiple plugs have code setters, individually. The cloud main controller sets power supply sequence to the cloud power management controllers of the plurality of power control devices as power failure occurs, and the cloud power management controllers control conductivity and interruption of power supply to the storage batteries. The code readers of the plurality of power control devices read sequence codes of the code setters respectively.

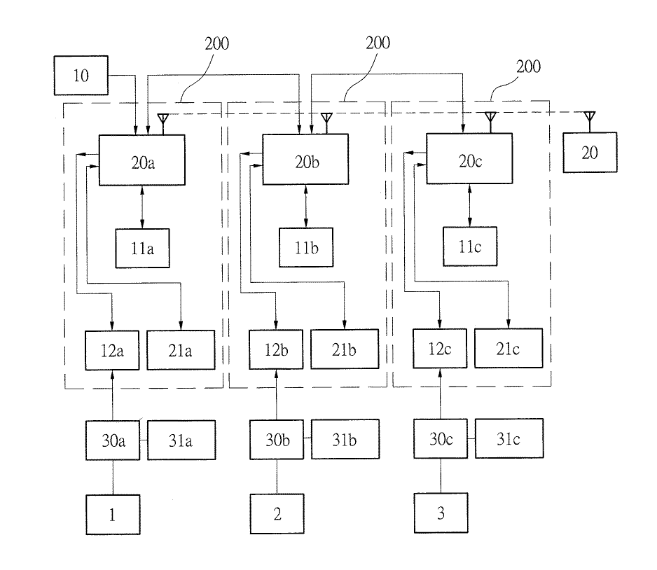

### FIELD OF THE INVENTION

The present invention relates to an uninterruptible power supply which controls sequence of power to electric apparatuses from the storage batteries based on using requirements.

### BACKGROUND OF THE INVENTION

A conventional uninterruptible power supply (UPS) contains at least one storage battery electrically connected with a power source and a socket on which at least one electric apparatus is coupled, such that when power is failed, the storage battery supplies the power to the electric apparatus. Preferably, a number of the at least one storage battery determines based on that of the at least one electric apparatus. However, the conventional uninterruptible power supply has following defects:

1. When one of the at least one storage battery is broken, the other storage batteries cannot supply the power to the at least one electric apparatus.

2. The at least one storage battery can only supply the power to its corresponding electric apparatus.

3. Wiring configuration of each of the at least one storage battery has to be changed, as desiring to supply the power to the other electric apparatuses.

4. The conventional uninterruptible power supply (UPS) cannot control power supply by using wireless signals.

The present invention has arisen to mitigate and/or obviate the afore-described disadvantages.

### SUMMARY OF THE INVENTION

The primary objective of the present invention is to provide an uninterruptible power supply which controls sequence of power to the electric apparatuses from the storage batteries based on using requirements.

To obtain above-mentioned objective, an uninterruptible power supply provided by the present invention contains: a plurality of power control devices, a cloud main controller, and multiple plugs.

The plurality of power control devices are in connection with a power source, and the plurality of power control devices include cloud power management controllers, storage batteries, code readers, and sockets, respectively. The multiple plugs have code setters, individually. The cloud main controller sets power supply sequence to the cloud power management controllers of the plurality of power control devices as power failure occurs, and the cloud power management controllers control conductivity and interruption of power supply to the storage batteries. The code readers of the plurality of power control devices read sequence codes of the code setters respectively.

### BRIEF DESCRIPTION OF THE DRAWINGS

The FIGURE is a block diagram of an uninterruptible power supply according to a preferred embodiment of the present invention.

### DETAILED DESCRIPTION OF THE PREFERRED EMBODIMENTS

With reference to the FIGURE, an uninterruptible power supply according to a preferred embodiment of the present invention comprises: a plurality of power control devices 200, a cloud main controller 20, and multiple plugs 30a, 30b, 30c. The plurality of power control devices 200 are in connection with a power source 10, and the plurality of power control devices 200 include cloud power management controllers 20a, 20b, 20c, storage batteries 11a, 11b, 11c, code readers 21a, 21b, 21c, and sockets 12a, 12b, 12c, respectively. The multiple plugs 30a, 30b, 30c have code setters 31a, 31b, 31c, individually. The cloud main controller 20 sets power supply sequence to the cloud power management controllers 20a, 20b, 20c of the plurality of power control devices 200 as power failure occurs, and the cloud power management controllers 20a, 20b, 20c control conductivity and interruption of power supply to the storage batteries 11a, 11b, 11c. The code readers 21a, 21b, 21c of the plurality of power control devices 200 read sequence codes of the code setters 31a, 31b, 31c respectively. Furthermore, the cloud main controller 20 controls the cloud power management controllers 20a, 20b, 20c and the plugs 30a, 30b, 30c by using wireless signals or wired signals, individually.

Thereby, when the power source 10 is failed, the uninterruptible power supply of the present invention operates as follows:

1. The cloud main controller 20 controls the cloud power management controllers 20a, 20b, 20c to electrically conduct with the storage batteries 11a, 11b, 11c, respectively, hence the storage batteries 11a, 11b, 11c supply power to electric apparatuses 1, 2, 3, individually.

2. As supplying the power to electric apparatus 1 in large power capacity, the cloud main controller 20 controls the power supply to the code setter 31a of the plug 30a in priority. As the power source is failed, the cloud power management controllers 20a, 20b, 20c of the plurality of power control devices 200 control the power to the electric apparatus 1 from the storage batteries 11a, 11b, 11c in priority.

3. The uninterruptible power supply of the present invention controls sequence of the power to the electric apparatuses 1, 2, 3 from the storage batteries 11a, 11b, 11c based on using requirements.

4. The cloud main controller 20 is connected with network via a computer so as to control the power sequence to the cloud power management controllers 20a, 20b, 20c by using the wireless signals.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An uninterruptible power supply comprising: a plurality of power control devices, a cloud main controller, and multiple plugs;
wherein the plurality of power control devices are in connection with a power source, and the plurality of power control devices include cloud power management controllers, storage batteries, code readers, and sockets, respectively;
wherein the multiple plugs have code setters, individually;
wherein the cloud main controller sets power supply sequence to the cloud power management controllers of the plurality of power control devices as power failure occurs, and the cloud power management controllers control conductivity and interruption of power supply to the storage batteries; and
wherein the code readers of the plurality of power control devices read sequence codes of the code setters respectively.

2. The uninterruptible power supply as claimed in claim 1, wherein the cloud main controller controls the cloud power management controllers and the plugs by using wireless signals or wired signals, individually.
